(19) United States
(12) Patent Application Publication
(10) Pub. No.: US 2005/0025385 A1
(43) Pub. Date: Feb. 3, 2005

(54) Image processing device and method therefor

(76) Inventors: Hui-Huang Chang, Cyonglin Township (TW); Hsin-Ying Ou, Kaohsiung City (TW); Chien-Hua Hsieh, Yonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/827,472

(22) Filed: Apr. 19, 2004

(30) Foreign Application Priority Data
Jul. 28, 2003 (TW) 092120572

(51) Int. Cl. G06K 9/56; G06K 9/40

(52) U.S. Cl. 382/276; 382/254

(57) ABSTRACT

An image processing device and a method for processing an image data, which includes a plurality of horizontal lines, each of which includes a plurality of pixel data. The image processing device includes at least one buffer unit for sequentially outputting a plurality of superpixels, and at least one processing unit, which is coupled to the at least one buffer unit, for sequentially processing the superpixels. Each superpixel includes a first pixel data and a second pixel data adjacent to the first pixel data, and the first pixel data and the second pixel data do not belong to the same horizontal line.

This application claims the benefit of Taiwan application Serial No. 092120572, filed Jul. 28, 2003, the subject matter of which is incorporated herein by reference.

### BACKGROUND OF THE INVENTION

1. Field of the Invention

The invention relates to a data processing device and a method therefor, and more particularly to an image data processing device and a method therefor.

2. Description of the Related Art

In an image processing system such as a scanner, or a multi-function peripheral (MFP), the image data usually has to be processed in several stages and then transferred to the output terminal for display, print or storage. These stages of processing may include the image data scaling, image enhancement, color processing, filtering, halftone processing, and data formatting for specific I/O apparatuses.

FIG. 1 is a block diagram showing a conventional image processing system. The image processing system, which is mainly composed of an image processing device 120 and a memory 130, is for performing the above-mentioned image processing procedures with respect to the image data DATA. The image data DATA is composed of a plurality of frames 110, each of which includes a plurality of horizontal lines 112. Each horizontal line includes a plurality of pixel data. In practice, one horizontal line serves as a basic unit in the image data DATA, and the horizontal lines on the frames are sequentially fed into the image processing device 120 for image processing.

The image processing device 120 includes a plurality of processing units 121, 123 and 125, each of which is for image-processing the fed image data DATA as mentioned hereinabove. For example, the processing units 121, 123 and 125 may be a scaling processor, a color processor and a halftone processor, respectively. Each processing unit in the image processing device 120 has to be coupled to the external memory 130. The conventional image processing procedures will be described in the following. Each processing unit has to load the image data at the proper position in the memory 130, process the image data, and then transfer the processed image data back to the memory 130 for storage. The next stage of image processing unit loads the processed image data, which is processed by the previous stage of processing unit and stored in the memory 130, for the next stage of image processing after the previous stage of image processing unit has finished its image processing procedure. The processes are performed in the same manner.

For example, when the image processing procedure is performed, a partial image data has to be taken. For instance, in the conventional method for scaling or filtering the partial image data 215, which is composed of a plurality of horizontal lines 215A, 215B and 215C in FIG. 3A, the processing unit in charge of scaling or filtering has to sequentially read the pixel data in the block corresponding to the partial image data 215 for scaling or filtering, and then store the processed data into the memory 130. Taking an image with a resolution of 600 dpi and a width of 8 inches as an example, if five horizontal lines have to be used at the same time and each horizontal line has 600 pixel data of 8 bits/pixel, then the required memory capacity has to be greater than or equal to 600×8×5=24000 bytes. Consequently, the prior art method has to use the memory with a considerable capacity.

Other drawbacks of the conventional image processing system will be described in the following. The prior art takes a longer period of time because each processing unit cannot perform the next stage of image processing until the previous stage of processing unit has processed at least one line and transferred the processed data to the memory 130. In addition, the image data is inputted to and outputted from the image processing device 120 and the external memory 130 in each of the conventional image processing procedures, so each processing unit in the image processing device 120 has to spend a lot of efficiency for the transferring and receiving of the processed data. Furthermore, because the data output/input bandwidth of the memory 130 is limited and shared by several processing unit, the next stage of image processing cannot be performed until the previous stages of processing unit has finished its procedure. Thus, the data processing speed is slowed, and the overall efficiency is reduced.

### SUMMARY OF THE INVENTION

It is therefore an object of the invention to provide an image processing device and a method therefor, which is capable of preventing each processing unit from accessing a memory outside the image processing device and capable of enhancing the operation efficiency.

The invention achieves the above-identified object by providing an image processing device and a method for processing an image data. The image data includes a plurality of horizontal lines, each of which includes a plurality of pixel data. The image processing device includes at least one buffer unit for sequentially outputting a plurality of superpixels, and at least one processing unit, which is coupled to the at least one buffer unit, for sequentially processing the superpixels. Each superpixel includes a first pixel data and a second pixel data adjacent to the first pixel data, and the first pixel data and the second pixel data do not belong to the same horizontal line.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a conventional image processing system.

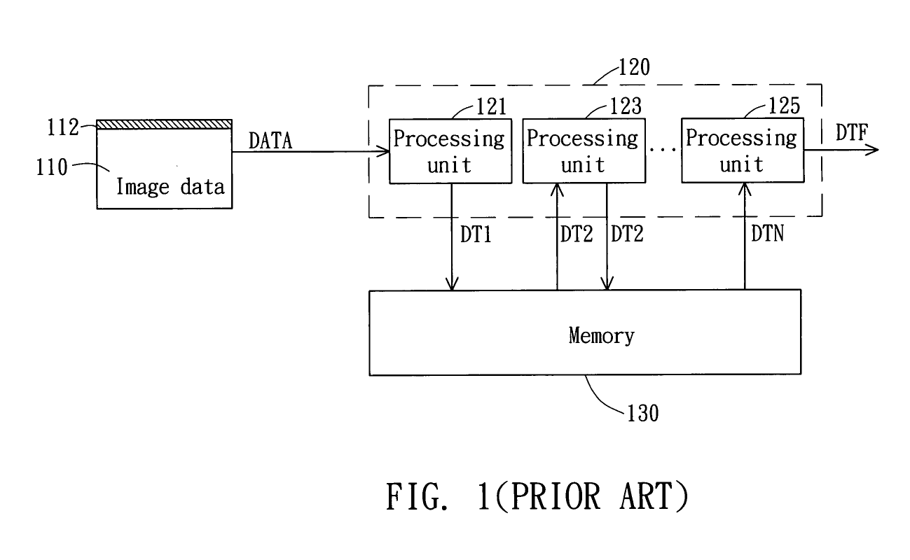

FIG. 2 is a block diagram showing an image processing system according to a first embodiment of the invention.

FIGS. 3A to 3C are schematic illustrations showing the concepts of the invention.

FIG. 4 shows a functional block diagram of a second embodiment of the invention.

### DETAILED DESCRIPTION OF THE INVENTION

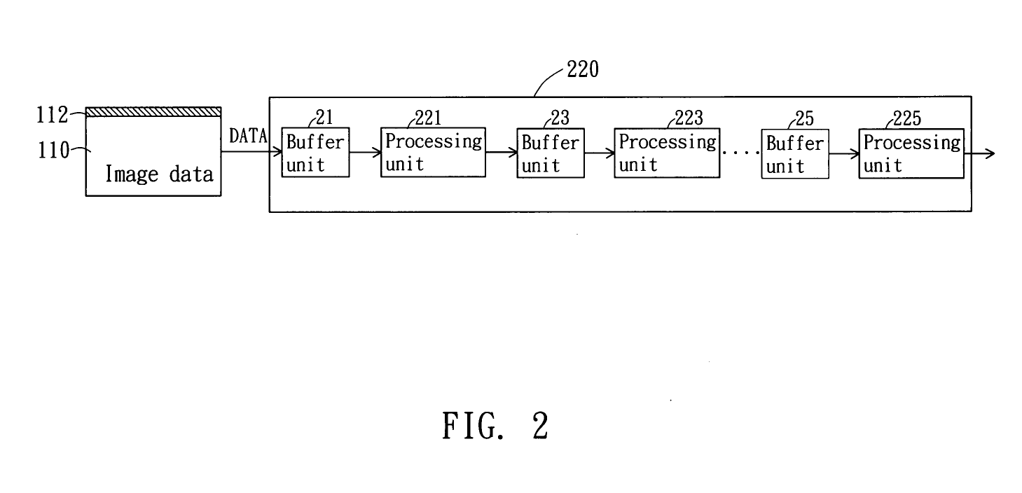

FIG. 2 is a block diagram showing an image processing system according to a first embodiment of the invention. The image processing device 220 has several processing units 221, 223 and 225 for processing the image data, respectively. In this embodiment, the processing units 221, 223, and 225 may be, for example, a scaling processor, a color processor, and a halftone processor, respectively. In addition, the image processing device 220 further has several buffer units 21, 23 and 25, each of which is disposed between two processing units and serially coupled to the two processing units. For example, the buffer unit 23 is coupled to the processing units 221 and 223. The buffer unit 23 is for temporarily storing the image data outputted from the previous stage of processing unit 221, and the stored image data may be provided to the next stage of processing unit 223 for the next stage of image processing. The buffer units 21, 23 and 25 may be memories or registers, such as SRAMs. In the image processing device 220 of the invention, disposing the buffer unit between two stages of processing unit solves the problem of incapable of performing the next stage of image processing after the previous stage of processing unit has finished the image processing in each processing unit. As long as the partial image data has been stored into the buffer unit, the next stage of processing unit can load the image data from the buffer unit for the next stage of image processing. Thus, the time required by the image processing procedures of the image processing device 220 may be greatly shortened. In addition, unlike the conventional memory capacity, the buffer unit can have the smaller memory capacity compared to the conventional art. Thus, the hardware cost may be greatly reduced. Furthermore, the digital data outputted from each processing unit in the image processing device 220 is buffered by the buffer unit and then transferred to the next processing unit for processing. Because the data does not have to be inputted to or outputted from the external memory, the image data processing speed is increased, and the efficiency of the processing unit is enhanced.

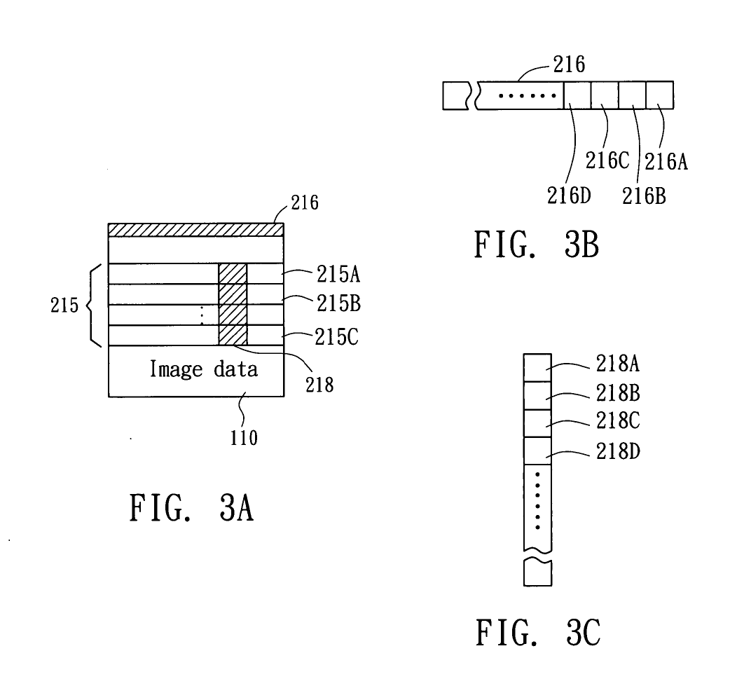

FIGS. 3A to 3C are schematic illustrations showing the concepts of the invention. In the typical image processing procedures, the pixel data 216A, 216B, 216C, 216D, and the like of the first horizontal line 216 in the left-top corner of the frame are sequentially inputted to the image processing device for image processing, as shown in FIG. 3B. In this description, this output sequence for the pixel data is referred to as a typical pixel data sequence. However, some portion of the frame, such as the two-dimensional image constituted by a plurality of adjacent horizontal lines 215A, 215B, and 215C (FIG. 3A) in the image data 110, has to be particularly processed. Alternatively, some specific pixel data, such as the vertically adjacent pixel data 218A, 218B, 218C, 218D, and the like. (FIG. 3C), has to be particularly processed. In this embodiment, the above-mentioned horizontal lines 215A, 215B, 215C and the like as a whole are referred to as a superline, and the above-mentioned vertically adjacent pixel data 218A, 218B, 218C, 218D and the like as a whole are referred to as a superpixel. In the above-mentioned condition, however, transferring the pixel data to the image processing device for various image processing procedures according to a fixed data transfer sequence of the prior art is not the most efficient way in some situations.

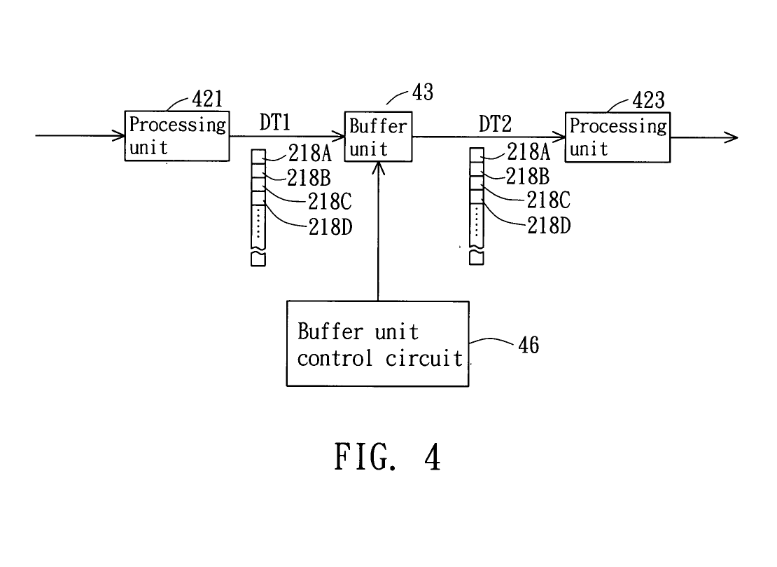

FIG. 4 shows a functional block diagram of a second embodiment of the invention. In addition to inputting and outputting the pixel data sequentially, the buffer unit 43 may also input and output a plurality of pixel data by taking one superpixel as a basic unit. In the second embodiment, the pixel data outputted from the processing unit 421 is inputted to the buffer unit 43 by taking the superpixel having a plurality of pixel data 218A, 218B, 218C, 218D, and the like as a basic unit. The buffer unit 43 stores one or more superpixels, and also outputs the superpixel having the plurality of pixel data 218A, 218B, 218C, 218D, and the like to the next stage of processing unit 423 for image processing (e.g., filtering or scaling) by taking the superpixel as a basic unit. Because both the input and output for the pixel data take the superpixel as the basic unit, it is possible to sequentially input data to the processing unit 423 for image processing (e.g., filtering or scaling) by taking the superpixel (e.g., superpixel 218) as the basic unit in this embodiment. Thus, the prior art requirement of sequentially reading the pixel data of the block corresponding to the partial image data 215 for image processing can be eliminated. Consequently, the efficiency of the image processing device may be enhanced, and the time for image processing may be shortened.

It is to be noted that sometimes the same image data is repeatedly used during the image processing procedures. Hence, in the second embodiment, the superpixel outputted from the buffer unit may have repeated pixel data. That is, some corresponding positions, on the image data, of the superpixels outputted from the buffer unit may be overlapped.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures. For instance, while it is described that the invention may output the pixel data according to different sequences by taking the superfine and the superpixel as examples, the invention is not limited thereto.

1. An image processing device for processing an image data, wherein the image data includes a plurality of vertical lines, wherein each of the vertical lines includes a plurality of pixel data, the image processing device comprising:
at least one buffer unit for buffering a plurality of superpixels, wherein all pixel data of each superpixel belong to the same vertical line; and
at least one processing unit, which is coupled to the at least one buffer unit, for sequentially processing the superpixels according to an image processing procedure.

2. The image processing device according to claim 1, wherein the image processing procedure can be one of the following: an image data scaling procedure, an image enhancement procedure, a color processing procedure, a halftone processing procedure, a filtering procedure, and an data formatting procedure with respect to specific I/O apparatuses.

3. The image processing device according to claim 1, wherein the at least one buffer unit receives the image data of at least one of the superpixels according to a first sequence, and outputting the image data of the superpixel according to a second sequence.

4. The image processing device according to claim 3, further comprising a buffer unit control circuit for controlling the image data of the superpixel to be outputted according to the second sequence.

5. The image processing device according to claim 1, wherein the superpixels comprises a first superpixel and a second superpixel, both of which include a first pixel data.

6. The image processing device according to claim 1 being installed in a scanner.

7. The image processing device according to claim 1 being installed in a multi-function peripheral (MFP).
